(19) United States
(12) Patent Application Publication
(10) Pub. No.: US 2024/0087870 A1
(43) Pub. Date: Mar. 14, 2024

(54) Pressure Control in Vacuum Chamber of Mass Spectrometer

(71) Applicant: DH Technologies Development Pte. Ltd., Singapore (SG)

(72) Inventors: Leigh BEDFORD, Ajax (CA); Hassan JAVAHERI, Richmond Hill (CA); Yang KANG, Richmond Hill (CA); Bradley B. SCHNEIDER, Bradford (CA)

(21) Appl. No.: 18/273,914

(22) PCT Filed: Jan. 21, 2022
(86) PCT No.: PCT/IB2022/050562

§ 371 Date: Jul. 24, 2023

Related U.S. Application Data
(60) Provisional application No. 63/141,252, filed on Jan. 25, 2021.

(51) Int. Cl. H01J 49/24

(52) U.S. Cl. CPC H01J 49/24

(57) ABSTRACT

In one aspect, an ion guide for use in a mass spectrometry system is disclosed, which comprises an inlet for receiving a plurality of ions entrained in a gas flow, and a plurality of rods arranged in a multipole configuration so as to provide a passageway through which the received ions can traverse. At least one of the rods is configured for application of a DC and/or an RF voltage thereto for generating an electromagnetic field within the passageway suitable for focusing the ions, and a controller configured to maintain an operational pressure of the ion guide within a predefined range.

### RELATED APPLICATIONS

The present application claims priority to U.S. Provisional Application No. 63/141,252 filed on Jan. 25, 2021, entitled “Q0 Pressure Control,” which is herein incorporated by reference in its entirety.

### BACKGROUND

The present disclosure relates generally to an ion guide for use in a mass spectrometry system, and more particularly to such an ion guide in which the operating pressure within the ion guide chamber can be adjusted in order to maintain the pressure in a predefined range or at a specific pressure.

Mass spectrometry (MS) is an analytical technique for measuring the mass-to-charge ratios of molecules within a sample, with both qualitative and quantitative applications. MS can be useful for identifying unknown compounds, determining the isotopic composition of elements in a molecule, determining the structure of a particular compound by observing its fragmentation, and quantifying the amount of a particular compound in a sample. Mass spectrometers detect chemical entities as ions such that a conversion of the analytes to charged ions must occur during the sampling process. Due to the accuracy and sensitivity requirements for most MS applications, complex samples are generally subjected to separation techniques prior to ionization.

In many mass spectrometers, ions are received via a sampling orifice of the mass spectrometer and are guided via one or more ion guides to one or more downstream components of the mass spectrometer. Some mass spectrometers include large sampling orifices (e.g., 1.55 mm diameter) to accommodate higher gas throughput, and hence a higher flux of incoming ions. To handle high gas flows, such mass spectrometers require high-speed pumps for efficient evacuation of various chambers of the spectrometer. The increase in the operating pressure of a chamber (e.g., a chamber in which an ion guide is positioned) beyond a certain threshold can adversely affect the operation of one or more pumps employed to evacuate that chamber, e.g., it can lead to overheating of the pump(s).

Further, in some mass spectrometers, an incoming gas is heated to improve declustering and desolvation for liberation of ions, for example, via heating the sampling orifice of the mass spectrometer. Such heating of the incoming gas can result in a decrease in the operating pressure of a downstream chamber (e.g., a chamber in which an ion guide is positioned). The lowering of the operating pressure beyond a certain limit can adversely affect the operation of the mass spectrometer, e.g., a substantial decrease in ion transmission due to ineffective collisional cooling.

Accordingly, there is a need for methods and systems for regulating the operating pressure within a chamber of a mass spectrometer (e.g., a chamber in which an ion guide is disposed).

### SUMMARY

In one aspect, a differentially pumped vacuum stage containing an ion guide for use in a mass spectrometry system is disclosed, which comprises an inlet for receiving a plurality of ions entrained in a gas flow, and a plurality of rods arranged in a multipole configuration so as to provide a passageway through which the received ions can traverse, where at least one of the rods is configured for application of a DC and/or an RF voltage thereto for generating an electromagnetic field within the passageway suitable for focusing the ions, and a controller configured to maintain an operational pressure of the ion guide within a predefined range.

In some embodiments, the inlet has at least one dimension (e.g., a diameter in case of a round inlet) that is equal to or greater than about 0.6 mm, e.g., in a range of about 1 mm to about 1.5 mm. By way of example, that dimension of the inlet (e.g., its diameter) can be in a range of about 0.72 mm to about 4 mm. Such a large diameter of the inlet of the mass spectrometer relative to those of conventional inlets allows the introduction of a higher gas flow into the mass spectrometer, thereby increasing the ion detection sensitivity of the mass spectrometer. In some embodiments, the inlet comprises an aperture in a plate, while in other embodiments the inlet comprises a capillary or a pipe. In other embodiments, the inlet may include multiple apertures and/or pipes.

In some embodiments, a pressure gauge is operably coupled to the differentially pumped vacuum stage for measuring the operating pressure within the differentially pumped vacuum stage and generating signals indicative of the measured pressure.

In some embodiments, a feedback circuit is in communication with the pressure gauge. The feedback circuit can be configured to apply control signals in response to the signals generated by the pressure gauge so as to maintain the operating pressure within a predefined range or at a predefined value.

In some embodiments, the predefined range and/or the predefined value of the pressure at which the differentially pumped vacuum stage is maintained is selected so as to optimize the transmission of ions having m/z ratios at specific values (or an m/z ratio at a single desired value), or in a desired range, through the ion guide and/or achieve an optimal declustering of one or more cluster ions.

In some embodiments, the differentially pumped vacuum stage can include an opening for providing a fluid connection between the differentially pumped vacuum stage and a pump for applying a negative pressure to the differentially pumped vacuum stage. In some such embodiments, the controller can be configured to control an adjustable flow restrictor that is disposed in the opening through which the differentially pumped vacuum stage chamber is coupled to the pump for adjusting the flow conductance between the chamber and the pump. By way of example, such a flow restrictor can include an adjustable aperture whose size can be adjusted, e.g., in response to control signals generated by the feedback system, so as to maintain the pressure in the differentially pumped vacuum stage within a desired range or at a specific value. By way of example, in some embodiments, the pressure within the differentially pumped vacuum stage can be maintained in a range of about 3 mTorr to about 12 mTorr, such as in a range of about 4 mTorr to about 10 mTorr, though any other desired range can also be employed. By way of further example, the pressure within the differentially pumped vacuum stage can be maintained in a range of about 1-10 Torr, such as in a range of 1.8-8 Torr.

The differentially pumped vacuum stage can be in fluid communication with an upstream sampling orifice of a mass spectrometer in which the differentially pumped vacuum stage is incorporated so as to receive ions generated by an upstream ion source. In some embodiments, the differentially pumped vacuum stage can be one of a plurality of differentially pumped vacuum stages containing a plurality of ion guides that are positioned in tandem. In some such embodiments, the differentially pumped vacuum stage may receive ions from another upstream differentially pumped vacuum stage. In some embodiments, one or more of the ion guides may be located in 2 or more differentially pumped vacuum stages.

In some embodiments, a mass spectrometer in which the differentially pumped vacuum stage is incorporated can include a heater for heating a surface surrounding a sampling orifice, which can be implemented, for example, as a pipe, a capillary, and/or a tube, of the mass spectrometer through which ions are introduced into the mass spectrometer, thereby heating the gas carrying the ions through the sampling orifice.

In some embodiments, a temperature sensor can be employed to measure the temperature of the heated surface and/or the heated gas as it passes through the orifice and/or at a location downstream of the orifice. A feedback circuitry can employ the temperature measurements to compute the operating pressure within a downstream differentially pumped vacuum stage containing at least one ion guide. By way of example, such computation of the operating pressure can be achieved based on previous calibration of a correlation between the measured temperature and the operating pressure. The controller can then be employed to adjust the pressure in the differentially pumped vacuum stage so as to maintain it within a predefined range or at a predefined value. In some embodiments, the controller can be configured to receive the temperature measurements and correlate the temperature measurements to the operating pressure within the differentially pumped vacuum stage. The controller can further provide control signals to maintain the pressure in the differentially pumped vacuum stage within a desired range and/or at a desired value.

In some embodiments, instead of or in addition to using an adjustable flow restrictor, the pumping speed of a pump employed to evacuate the differentially pumped vacuum stage chamber (e.g., an ion guide chamber) can be adjusted so as to maintain the operating pressure in the differentially pumped vacuum stage within a desired range and/or at a desired value. In some embodiments, such adjustment of the pumping speed can be performed in response to pressure data obtained by a pressure sensor that is operably coupled to the one or more differentially pumped vacuum stage chambers. This can be accomplished, for instance, by adjusting the frequency of a roughing pump.

In some embodiments, the controller can be configured to receive one or more temperature settings associated with one or more heating elements of the mass spectrometry system and to adjust the operational pressure of the ion guide based thereon. For example, in some aspects, the controller can be configured to compute the operational pressure based on calibration data correlating the temperature setting to the operational pressure. In some related aspects, the controller can be configured to compare said computed operational pressure with a predefined pressure range to determine whether said computed operational pressure lies outside of said predefined range.

In a related aspect, a mass spectrometry system is disclosed, which comprises a sampling plate having a sampling orifice, a capillary, a tube, or a pipe for receiving a plurality of ions entrained in a gas flow, and at least one ion guide positioned downstream of said sampling orifice, the capillary, the tube, or the pipe. The ion guide can include an inlet port for receiving the gas flow containing the plurality of ions, a plurality of rods arranged in a multipole configuration, e.g., in a quadrupole configuration, so as to provide a passageway through which the received ions can traverse, where at least one of the rods is configured for application of a DC and/or an RF voltage thereto for generating an electromagnetic field within the passageway that is suitable for focusing the ions. The differentially pumped vacuum chamber containing at least one ion guide can further include an adjustable flow restrictor for adjusting a flow conductance of the gas flow between the chamber and a pump employed to apply a negative pressure to the chamber so as to adjust the operating pressure of the ion guide.

The ion guide can further include an outlet through which the focused ions exit the ion guide. A mass analyzer can be disposed downstream of the ion guide for receiving the ions exiting the ion guide and providing a mass analysis of those ions. In some embodiments, the rods of the ion guide can be replaced with ring electrodes.

In some embodiments of the above mass spectrometer, an orifice of the mass spectrometer can have at least one dimension, e.g., a diameter, that is equal to or greater than about 0.6 mm, e.g., in a range of about 1 mm to about 4 mm (e.g., about 1.5 mm). Although the inlet can have a variety of different cross-sectional profiles, in many embodiments, it is circular with a diameter in the above range.

The above mass spectrometer can further include a feedback circuit that is configured to apply one or more control signals based on the pressure data that is indicative of the operating pressure within the chamber containing the ion guide so as to maintain the operating pressure in the ion guide chamber within a predefined range and/or at a predefined value.

In some embodiments of the above mass spectrometer, a pressure gauge is operably coupled to at least one ion guide chamber to measure the operating pressure within the ion guide chamber and generate signals indicative of the measured operating pressure. The pressure gauge can also be operably coupled to the feedback circuit to transmit the pressure measurement signals to the feedback circuit. The feedback circuit can be in turn configured to apply control signals to one of a roughing pump and/or an adjustable flow restrictor so as to maintain the ion guide's operating pressure within the desired range and/or value.

In some embodiments, the differentially pumped vacuum stage includes an opening for providing a fluid connection with a pump that is configured to apply a negative pressure to the ion guide chamber. In some such embodiments, the adjustable flow restrictor can be in the form of a diaphragm having an adjustable aperture that is positioned so as to adjust the flow conductance through the opening that connects the ion guide chamber to the pump.

In some such embodiments, the feedback circuit can generate one or more control signals for changing the size (e.g., the diameter) of the adjustable aperture so as to maintain the operating pressure within the desired range and/or at the desired value. By way of example, the predefined pressure range can be from about 3 mTorr to about 12 mTorr. For example, in some embodiments, the predefined pressure range can be about 1-10 Torr. It should be understood that other pressure ranges may also be employed, e.g., depending on a particular application. For example, a target pressure of a chamber in which an ion guide is positioned can vary depending upon the specific design of the ion guide (e.g., its length and/or mechanical design) located within the differentially pumped vacuum stage.

In some embodiments, the mass spectrometer can include a heater for heating the gas carrying the ions into the ion guide. For example, the heater can be thermally coupled to an orifice of the mass spectrometer, which can be formed in an orifice plate, for heating the orifice plate, and hence the gas flowing through the orifice. A curtain plate can be disposed upstream of the orifice plate and can include an aperture for receiving ions from an upstream ion source. A curtain gas flow mechanism can be employed to direct a gas into a space between the curtain plate and the orifice plate. In some such embodiments, a temperature sensor can be employed for measuring the temperature of the heated orifice plate and/or the heated gas. A feedback control circuitry can receive the temperature data generated by the temperature sensor and can correlate the measured temperature to an operating pressure in the ion guide (e.g., based on previous calibration data).

The feedback control circuitry can further be configured to apply control signals to various elements, e.g., to control the pump's speed and/or the size of an adjustable aperture formed in a diaphragm that separates the ion guide chamber from the pump. Additional heaters can be included in the ion source or on other structures within the curtain chamber. The heated orifice plate may also be replaced with a heated tube, a pipe, or an inlet capillary.

In some embodiments, the mass spectrometer can include a plurality of ion guides that are disposed in series, where at least one of the ion guides (in some embodiments all of the ion guides) includes a system according to the present teachings for maintaining the ion guide's operating pressure within a predefined range and/or at a predefined value. In some such embodiments, the operating pressure within each ion guide chamber is controlled independent of the operating pressure in the other ion guides. In some implementations, the operating pressure in the ion guide chambers decreases from the ion guide chamber that is positioned closest to the ion-receiving orifice of the mass spectrometer to the ion guide chamber that is positioned farthest from that orifice. In some embodiments, the control of the operating pressure within an ion guide chamber can be employed to maintain the operating pressure within that ion guide as well as a plurality of ion guides disposed downstream of that ion guide in desired pressure ranges and/or values.

In some embodiments, the mass spectrometer system can include additional structure(s) in fluid communication with (and/or sealed to) the inlet orifice. For example, an interface (e.g., a nanoflow interface or a differential mobility spectrometer (DMS)), can be positioned upstream of an inlet orifice of the mass spectrometer (e.g., in the curtain chamber between the curtain plate and the orifice plate). For example, in one embodiment, a nanoflow interface with a heated laminar flow chamber, such as that described in U.S. Pat. Nos. 7,462,826 and 7,098,452, which are herein incorporated by reference in their entirety, can be employed. In another embodiment, a DMS such as that described in U.S. Pat. No. 8,084,736, which is herein incorporated by reference in its entirety, can be employed. In many embodiments, the addition of such upstream interfaces can result in direct heating in front of the orifice of the mass spectrometer, which can in turn result, in absence of the implementation of pressure-adjustment mechanisms of the present teachings, in undesirable pressure fluctuations in the downstream differentially pumped vacuum stages.

In some embodiments, a mass spectrometry system according to the present teachings can include a 3-stage interface with an ion guide, referred to as a DJET ion guide as described, e.g., in U.S. Pat. No. 10,475,633, s which is herein incorporated by reference in its entirety, installed in the first pressure stage. In some embodiments, the mass spectrometry system can include quadrupole ion guides in the 2^{nd} and 3^{rd} vacuum stages. In some embodiments, a pressure adjustment system according to the present teachings can be operable in one or more of the three vacuum stages.

In a related aspect, a mass spectrometry system is disclosed, which includes a sampling plate having a sampling orifice for receiving a plurality of ions entrained in a gas flow, and at least one ion guide positioned downstream of the sampling orifice. The ion guide can include an inlet port for receiving the gas flow containing the plurality of ions, a plurality of rods arranged in a multipole configuration so as to provide a passageway through which the received ions can traverse, at least one of said rods being configured for application of a DC and/or RF voltage thereto for generating an electromagnetic field within said passageway suitable for focusing the ions, a pressure-adjusting element for adjusting the operational pressure of the ion guide, and an outlet port through which the focused ions exit the ion guide and at least one downstream mass analyzer for receiving the focused ions and configured to provide mass analysis of those ions.

In a related aspect, a mass spectrometer system is disclosed, which includes a differentially pumped chamber containing an ion guide, and a pressure-adjusting element for adjusting an operational pressure of the ion guide. The ion guide can be implemented, for example, using a plurality of rods arranged in a multipole configuration or a plurality of ring electrodes placed in series and having aligned openings through which ions can pass.

Further understanding of various aspects of the present teachings can be obtained by reference to the following detailed description in conjunction with the associated drawings, which are described briefly below.

### BRIEF DESCRIPTION OF THE DRAWINGS

FIG. 1 schematically depicts an ion guide according to an embodiment of the present teachings,

FIG. 2 schematically depicts an ion guide according to another embodiment of the present teachings,

FIG. 3A schematically depicts an implementation of a control circuitry suitable for use in an embodiment of the present teachings,

FIG. 3B schematically depicts a mass spectrometer according to an embodiment of the present teachings in which a plurality of ion guides according to an embodiment of the present teachings is incorporated,

FIG. 4 schematically depicts a mass spectrometer according to another embodiment,

FIG. 5 schematically depicts a mass spectrometer according to another embodiment in which three ion guides according to an embodiment of the present teachings are positioned in tandem, and the aperture separating the 2^{nd} and 3^{rd} chambers has an adjustable cross sectional area,

FIG. 6 schematically depicts a mass spectrometer according to an embodiment in which a temperature sensor coupled to an orifice plate of the mass spectrometer is utilized to measure the temperature of gas passing through the orifice and correlate the measured temperature to an operating pressure within one or more downstream ion guides,

FIG. 7 schematically depicts a mass spectrometer according to another embodiment in which the pressure within each of a plurality of ion guides is maintained within a desired range by adjusting the speed of a pump employed to apply a negative pressure to that ion guide,

FIG. 8A is a partial schematic view of a mass spectrometer according to an embodiment in which a nanoflow interface is positioned between the curtain plate and the orifice plate,

FIG. 8B is a partial schematic view of another embodiment of a mass spectrometer according to the present teachings in which a DMS is placed upstream of the spectrometer's orifice,

FIG. 8C schematically depicts a user interface according to an embodiment of the present teachings, which can be employed to enter m/r ratios of interest,

FIG. 9A shows the reserpine ionogram measured with Q0 pressure maintained at 3.7 mTorr,

FIG. 9B shows the reserpine ionogram measured with Q0 pressure maintained at 2.7 mTorr,

FIGS. 10A and 10B depict a series of peaks obtained for reserpine via flow injection of reserpine into a mass spectrometer according to an embodiment of the present teachings,

FIGS. 11A and 11B show a series of peaks obtained for minoxidil via flow injection of minoxidil into a mass spectrometer according to an embodiment of the present teachings,

FIG. 12A shows the measured Q0 pressure as a function of temperature measured on the heated inlet upstream of sampling orifice,

FIG. 12B presents reserpine ion signal at various heated inlet gas temperatures while maintaining the operating pressure within the Q0 ion guide above 3 mTorr,

FIG. 13A shows the change in the operating pressure of the Q0 as a function of the temperature of the heated inlet with different laminar flow chamber inner diameters,

FIG. 13B shows the reserpine ion signal that was measured under conditions depicted in FIG. 13A,

FIG. 14A shows a mass spectrum of a cesium cluster ion having an m/z of approximately 3108 obtained using a breadboard time-of-flight mass spectrometry system with a 3-stage DJET front end configured for receiving very large molecules and a Q0 ion guide pressure less than 5 mTorr, and

FIG. 14B shows the mass spectrum of the cesium cluster ion obtained with the pressure of the Q0 ion guide at 7 mTorr.

### DETAILED DESCRIPTION

The present teachings are generally directed to one or more differentially pumped vacuum stages containing ion guides that include a system for maintaining the operating pressure within a predefined range and/or at a predefined value. As discussed in more detail below, in some embodiments, the pressure within such a differentially pumped vacuum stage is measured directly or inferred from one or more temperature measurements at one or more locations within the differentially pumped vacuum stage chamber (e.g., an ion guide chamber) and/or upstream of the differentially pumped vacuum chamber (e.g., upstream of an ion guide chamber), for example, at the heated inlet orifice of a mass spectrometer in which the differentially pumped vacuum stage is incorporated. In some embodiments, the inlet orifice can be replaced with a heated tube. A controller (including feedback circuitry) can apply control signals to a pressure-adjustment element, which is operably coupled to the ion guide chamber, to adjust the pressure within the ion guide chamber so as to maintain the pressure in a desired range and/or at a desired value. In the following embodiments, the present teachings are described with reference to ion guides, but it should be understood that the present teachings can also be used to control the operating pressure within a variety of differentially pumped vacuum stages.

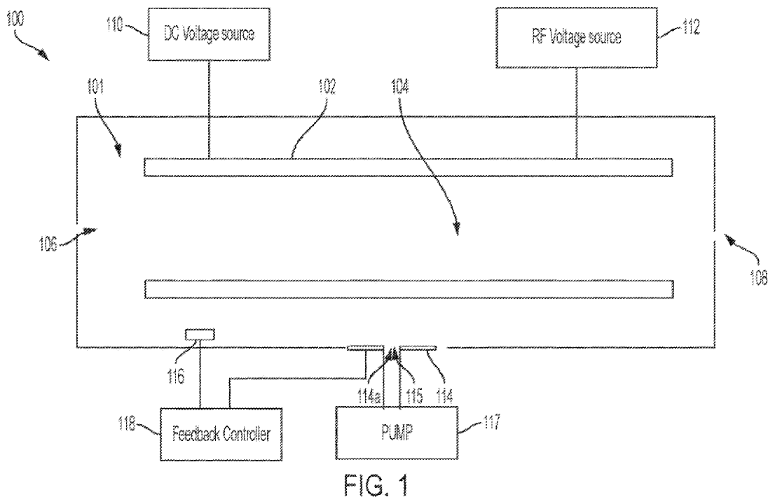

FIG. 1 schematically depicts a differentially pumped vacuum stage 100 according to an embodiment, which includes a chamber 101 in which a plurality of rods 102 are arranged according to a quadrupole configuration to provide a passageway 104 through which ions received via an inlet port 106 of the vacuum stage pass to reach an outlet port 108 through which the ions exit the vacuum stage. Although in this embodiment the plurality of rods 102 are arranged according to a quadrupole configuration, in other embodiments the rods can be arranged according to other multipole configurations, such as, for example, a hexapole, an octupole, a decapole, or a dodecapole configuration.

A DC voltage source 110 and an RF voltage source 112 apply DC and/or RF voltages to one or more rods of the ion guide to provide an electromagnetic field within the passageway that can provide radial confinement of ions of interest. By way of example, the RF voltage can have a frequency in a range of about 200 kHz to about 6 MHz, e.g., in a range of about 1 MHz to about 5 MHz, and an amplitude in a range of about 0 to about 500 volts, e.g., in a range of about 10 volts to about 400 volts, or in a range of about 100 volts to about 300 volts Further, in some embodiments, the DC voltage can have an amplitude in a range of about 0 volt to about 1000 volts, e.g., in a range of about 10 volts to about 500 volts or in a range of about 100 volts to about 300 volts.

In this embodiment, the differentially pumped vacuum stage 100 includes an adjustable flow restrictor 114 for adjusting the operating pressure within the ion guide chamber. In this embodiment, the flow restrictor 114 is in the form of a diaphragm disposed at an opening 115 of the chamber 101 that couples the chamber 101 to a pump 117 (e.g., a turbo pump, a rotary vane pump, a roughing pump, or any other suitable pump or combination of pumps) for maintaining the pressure within the chamber in a desired range or at a desired value. The diaphragm 114 includes an adjustable aperture 114a, where the diameter of the aperture can be adjusted to control the flow conductance between the chamber and the pump, thereby adjusting the operating pressure within the chamber.

In this embodiment, a pressure sensor 116 coupled to the ion guide chamber 101 measures the operating pressure within the ion guide chamber and generates signals indicative of the pressure measurements. A feedback control circuitry 118 is operably connected to the pressure sensor 116 and the adjustable aperture 114a. The feedback control circuitry 118 receives the pressure measurement signals from the pressure sensor and applies control signals to the adjustable aperture to change the aperture's diameter in order to bring the operating pressure within the ion guide chamber into a desired pressure range or at a desired pressure value.

For example, when the measured pressure exceeds a predefined threshold, the feedback control circuitry 118 can apply control signals to the adjustable aperture 114a to increase the aperture's diameter, thereby enhancing the flow conductance though the aperture, and consequently reducing the pressure within the chamber into a desired range. Alternatively, when the measured pressure is below a predefined threshold, the feedback control circuitry 118 can apply control signals to the adjustable aperture 114a to decrease the aperture's diameter, thereby reducing the flow conductance through the aperture, and consequently increase the pressure within the chamber into a desired range. In some implementations of such an embodiment, the pump's speed is maintained substantially constant while the size of the aperture (e.g., the aperture's diameter) is adjusted to control the operational pressure within the ion guide chamber. As discussed in more detail below, in other embodiments, the size of an opening connecting the ion guide chamber to the pump can be fixed while the pump's speed is adjusted to maintain the operating pressure in the ion guide chamber within a predefined range or at a predefined value. Further, in some embodiments, both the size of the port connecting the ion guide chamber to the pump and the pump's speed can be adjusted in order to maintain the pressure within the ion guide chamber within a predefined range or at a predefined value. In some embodiments, the size of the port and the pump speed can be maintained constant and the inlet port conductance can be adjusted, for instance by employing an adjustable inlet port diameter.

For example, in some embodiments, the feedback control circuitry 118 controls the diameter of the adjustable aperture so as to maintain the pressure within the ion guide chamber in a range of about 1 Torr to about 10 Torr, e.g., in a range of about 4-8 Torr, or in a range of about 3-12 mTorr, though other pressure ranges can also be employed.

As noted above, in some embodiments, instead of or in addition to employing an adjustable aperture disposed at an opening that connects the ion guide chamber to the pump, the pump's speed can be adjusted in response to pressure measurement signals generated by the pressure sensor so as to maintain the operating pressure in the ion guide chamber within a desired range or at a desired value.

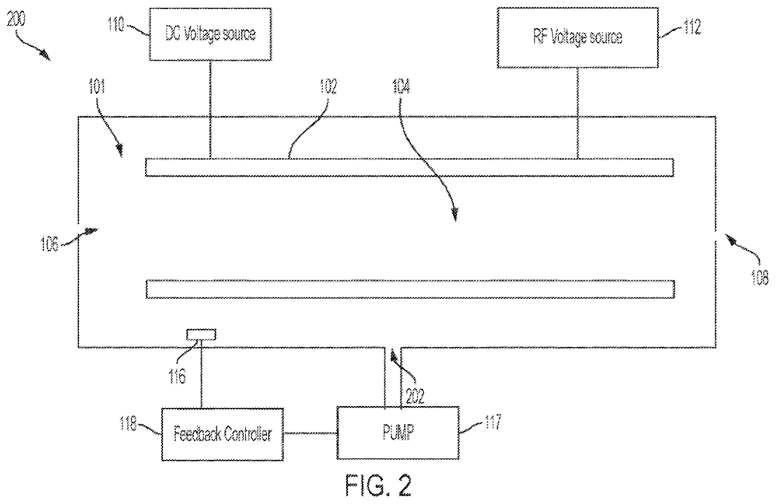

For example, FIG. 2 schematically depicts a differentially pumped vacuum chamber 200 according to such an embodiment, which similar to the previous embodiment includes a vacuum chamber 101 in which a plurality of rods 102 are arranged according to a quadrupole configuration to provide a passageway 104 through which ions received via an inlet port 106 of the vacuum stage pass to reach an outlet port 108 through which the ions exit the ion guide. Although in this embodiment the plurality of rods 102 are arranged according to a quadrupole configuration, in other embodiments the rods can be arranged according to other multipole configurations, such as, for example, a hexapole configuration, an octapole, a decapole, or a dodecapole. In other embodiments, the ion guide may comprise a series of ring electrodes.

With continued reference to FIG. 2, similar to the previous embodiment, the ion guide chamber 101 further includes an opening 202, which fluidly couples the ion guide chamber to the pump 117 for maintaining the operating pressure within the ion guide chamber in a predefined pressure range or at a predefined value. Rather than using an adjustable aperture, in this embodiment a feedback control circuitry 118 is configured to apply control signals to the pump 117 for adjusting the pump's speed in response to pressure measurement signals generated by the pressure sensor 116 so as to maintain the operating pressure in the ion guide chamber within a predefined range or at a predefined value. For example, when a pressure measurement signal generated by the pressure sensor 116 indicates that the pressure in the ion guide chamber is greater than a predefined threshold, the feedback control circuitry 118 applies control signals to the pump 117 in order to increase the pump's speed so as to reduce the operational pressure in the ion guide chamber in order to bring the operational pressure in the ion guide chamber into the desired pressure range or value.

Alternatively, when a pressure measurement signal generated by the pressure sensor 116 indicates that a pressure in the ion guide chamber is less than a predefined threshold, the feedback control circuitry 118 applies control signals to the pump 117 so as to reduce the pump's speed in order to increase the operating pressure in the ion guide chamber in order to bring the pressure in the ion guide chamber into the desired pressure range or value.

A variety of commercially available pressure sensors can be employed in the practice of the present teachings. By way of non-limiting example, the pressure sensor may include a capacitance manometer such as a Baratron to measure pressures from about 1-1000 Torr. In some embodiments, such a capacitance manometer can be suitable for a first and/or second differentially pumped vacuum chamber of a mass spectrometer. For chambers maintained at a lower pressure, in some embodiments, the pressure sensor can be a Pirani Gauge, a thermocouple gauge, or a hot filament ion gauge by way of non-limiting example.

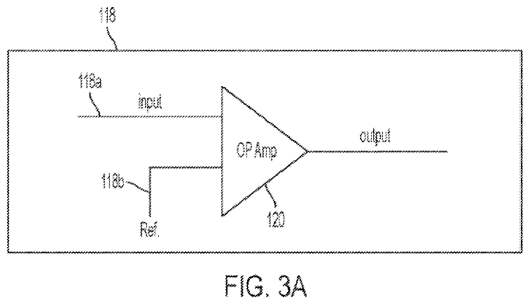

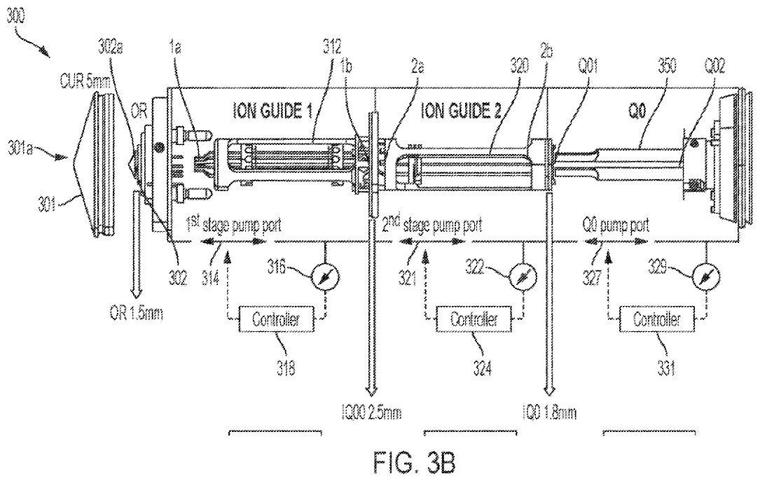

Further, the feedback control circuitry 118 can be implemented using known techniques in the art as informed by the present teachings. By way of illustration, FIG. 3A schematically depicts one such implementation of the feedback control circuitry 118 in which a comparator 120, e.g., an operational amplifier, receives a pressure signal at data input 118a thereof and compares that pressure signal with a reference signal applied to its reference input 118b. If the difference between the measured pressure signal and the reference signal is greater than a predefined threshold, the comparator generates an output control signal for application to the adjustable flow restrictor and/or the pump. As is known in the art, the output signal generated by the comparator can be amplified and/or otherwise configured to ensure establishing a stable feedback loop for maintaining the operating pressure in the ion guide chamber within a predefined range and/or at a predefined value.

As discussed in more detail below, in some embodiments, multiple ion guides can be placed in tandem, and the pressure within one or more (and in some cases all) of the ion guides can be maintained within a desired range by employing the present teachings. In some embodiments, the operating pressure in each ion guide chamber can be controlled independent of the pressure in other ion guide chambers. In some other embodiments, the control of the pressure in an ion guide chamber can be achieved by controlling the pressure in one or more upstream ion guide chambers using the present teachings.

An ion guide according to the present teachings can be incorporated in a variety of mass spectrometers, including, without limitation, quadrupole, triple quadrupole, time-of-flight spectrometers, ion traps and combinations thereof. By way of example, FIG. 3B schematically depicts such a mass spectrometer 300 that includes a curtain plate 301 and an orifice plate 302 having openings 301a and 302a through which ions generated by an upstream ion source can pass to reach downstream components of the mass spectrometer. In accordance with various aspects of the present teachings, a curtain gas supply (not shown in this figure) can provide a curtain gas flow (e.g., of N₂) between the curtain plate 301 and orifice plate 302 to aid in keeping the downstream section of the mass spectrometer system clean by declustering and evacuating large neutral particles.

In this embodiment, the ions passing through an inlet of the orifice plate enter an ion guide 1 (herein also referred to as DJET) via an inlet 1a thereof. The ion guide 1 includes a set of rods 312 arranged in a dodecapole configuration so as to provide a passageway for the transit of ions through the ion guide. The application of DC and/or RF voltages to one or more of these rods, in a manner known in the art, in combination with gas dynamics can allow the ion guide to focus the ions for transmission to downstream ion guides, as discussed below. In this embodiment, the operating pressure within the ion guide can be maintained in a range of about 4 to about 8 Torr.

An opening (herein also referred to as a port) 314 connects the ion guide 1 to a pump (not shown in this figure), such as a rotary vane or a roughing pump, that can apply a negative pressure to the ion guide chamber. In this embodiment, an adjustable flow restrictor (not shown in this figure), such as the adjustable restrictor 114 discussed above, can be disposed in the opening 314 to allow adjusting the flow conductance of the fluid connection between the ion guide chamber and the pump. A pressure sensor 316 is employed to measure the operating pressure within the ion guide chamber and transmit signals indicative of the measured pressure to a controller 318 (herein also referred to as a feedback control circuit), which can in turn adjust the size of the flow restrictor's aperture, e.g., in a manner discussed above, to maintain the operating pressure within a desired pressure range or a at a specific desired pressure. In particular, in this embodiment, the controller can be configured to maintain the operating pressure in the ion guide chamber in a range of about 4 Torr to about 8 Torr.

With continued reference to FIG. 3B, the ions exit the ion guide 1 via an outlet 1b thereof to reach a downstream ion guide 2 (herein also referred to as QJET) via an inlet 2a of the ion guide 2. An ion lens IQ00 separates the ion guide 1 and the ion guide 2 and includes an aperture through which ions pass. A DC voltage differential between the ion lens IQ00 and the rods of the ion guide 1 can accelerate the ions and hence increase their kinetic energy, which can in turn facilitate the declustering of at least a portion of adduct ions, when present in the ion flux, as the ions are subjected to gas expansion as they pass into ion guide 2, which is maintained at a lower pressure.

Ion guide 2 includes four rods 320 disposed in an evacuated chamber and arranged relative to one another in a quadrupole configuration to provide a passageway for the transit of ions therethrough. An opening 321 formed in the wall of the chamber containing ion guide 2 provides fluid coupling between the ion guide 2 chamber and a pump (not shown), which can operate to evacuate the ion guide chamber. An adjustable restrictor (not shown in this figure) is disposed within the opening 321 to allow adjusting the flow conductance between the ion chamber and the pump, thereby adjusting the operating pressure within the ion guide chamber.

More specifically, a pressure sensor 322 is operably coupled to the ion guide chamber to measure the operating pressure within the chamber and generate signals indicative of the pressure. A controller 324 in communication with the pressure sensor 322 receives the pressure measurement signals from the pressure sensor and applies control signals to the adjustable aperture of the adjustable flow restrictor in response to the received signals so as to maintain the operating pressure within the ion guide chamber in a range of about 1.5 Torr to about 4 Torr, though in other embodiments other pressure ranges can also be employed. Similar to the ion guide 1, the ion guide 2 can employ a combination of gas dynamics and electromagnetic fields to provide focusing of the ions.

Ions exiting an outlet 2b of the ion guide 2 pass through an opening in an ion lens IQ0 to enter a third ion guide Q0 via an inlet thereof, where the ion guide Q0 can provide additional focusing of the ions. More specifically, similar to the ion guide 2, the ion guide Q0 includes four rods 350 that are disposed in an evacuated chamber and are arranged in a quadrupole configuration providing a passageway for ion transit. Again, RF and DC voltages can be applied to one or more rods of the ion guide Q0 to generate a quadrupolar electromagnetic field for radial confinement and focusing of the ions. An opening 327 provided in the wall of the ion guide chamber allows coupling the ion guide chamber to a pump (not shown in this figure) for applying a negative pressure to the ion guide chamber.

In this embodiment, the operating pressure within the ion guide chamber Q0 is maintained lower than the respective operating pressures in the ion guides 1 and 2. More specifically, in this embodiment, the operating pressure within the ion guide Q0 is maintained in a range of about 3 mTorr to about 12 mTorr, though other pressure ranges may be employed in other embodiments.

A pressure sensor 329 is operably coupled to the chamber of the ion guide Q0 to measure the operating pressure within that chamber and generate signals indicative of the measured pressure. The pressure sensor can transmit its measurement signals to a controller 331, which can in turn adjust an adjustable aperture of an adjustable flow restrictor positioned in the opening 327, thereby controlling the flow conductance between the ion guide and the pump. As discussed in detail above, when the pressure measurement signals generated by the pressure sensor indicate an operating pressure above a predefined high threshold, the controller can apply control signals to the flow restrictor to increase the size (e.g., diameter) of the flow restrictor's aperture in order to enhance the flow conductance between the chamber and the pump, thereby lowering the pressure within the chamber. Alternatively, when the pressure sensor indicates an operating pressure below a predefined low threshold, the controller can apply control signals to the flow restrictor to decrease the aperture's size, thereby decreasing the flow conductance between the ion chamber and the pump, thereby increasing the operating pressure within the ion guide chamber.

The ions can exit the Q0 ion guide via an outlet Q02 thereof to reach downstream components of the mass spectrometer. For example, one or more mass filters and/or mass analyzers disposed downstream of the Q0 ion guide can receive the ions exiting the Q0 ion guide. For example, a mass filter (not shown in this figure) disposed downstream of the Q0 ion guide can receive the ions and can select ions having m/z ratios within a desired window. The mass filter can include a single mass filter or a plurality of mass filters (and/or mass analyzers) placed in tandem relative to one another. Such mass analyzers can include, without limitation, a single quadrupole, triple quadrupole, a time-of-flight analyzer, one or more ion traps, collision cells, or combinations thereof.

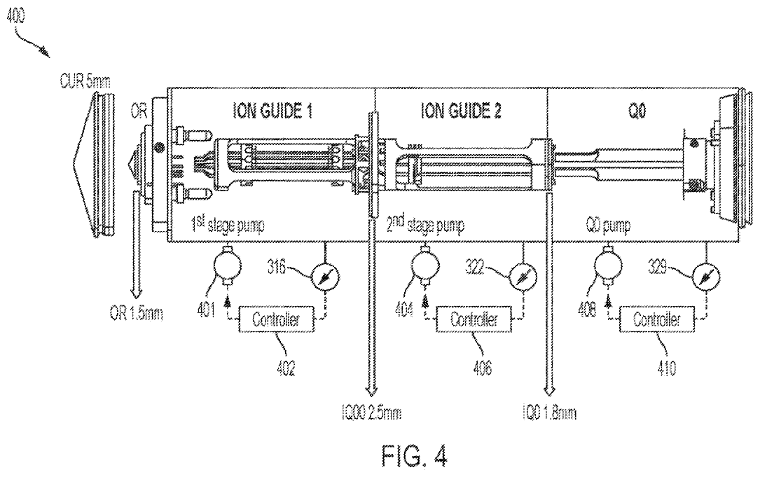

As noted above, in some embodiments, rather than using an adjustable flow restrictor, the speed of a pump utilized to apply a negative pressure to an ion guide chamber can be adjusted to ensure that the pressure within the ion guide chamber would remain within a desired pressure range, or at a desired pressure value. By way of example, FIG. 4 schematically depicts a mass spectrometer 400 that includes the three ion guides discussed above in connection with FIG. 3B, which are positioned in tandem. However, in the spectrometer 400, rather than adjusting the aperture of an adjustable flow restrictor for adjusting the pressure within an ion guide chamber, the speed of a pump coupled to an ion guide chamber can be adjusted for adjusting the pressure within the ion guide chamber.

More specifically, a pump 401 is fluidly coupled to the chamber of the ion guide 1 for applying a negative pressure to the ion guide chamber. A controller 402 receives the pressure measurement data generated by the pressure sensor 316 and is configured to apply control signals to the pump 401 in response to the pressure measurement data to adjust the pump's speed so as to maintain the pressure within the ion guide 1 in a predefined pressure range. For example, in this embodiment, the pressure in the ion guide 1 is maintained in a range of about 4 Torr to about 8 Torr.

Similarly, the ion guide 2 includes a pump 404 that is coupled to the ion guide chamber of the ion guide 2 and a controller 406 receives pressure data generated by the pressure sensor 322 and applies one or more control signals to the pump 404 to adjust the pump's speed for maintaining the pressure in the ion guide chamber within a desired pressure range, in this embodiment, in a range of about 1.5 Torr to about 4 Torr.

With continued reference to FIG. 4, the ion guide Q0 also includes a pump 408 for applying a negative pressure to the ion guide chamber, the pressure sensor 329 and a controller 410 that receives the pressure data from the pressure sensor 329 and applies control signals to the pump 408 to adjust the pump's speed so as to maintain the operating pressure in a desired pressure range, e.g., in this embodiment, within a pressure range of about 3 mTorr to about 12 mTorr. In some embodiments, rather than employing three pressure controllers 402, 406, and 410, one or a combination of any two pressure controllers can be employed. For example, a single pressure controller can be configured to receive pressure data from multiple pressure sensors and compute the requisite control signal for application to each pump associated with an ion guide. Alternatively, two pressure controllers can be employed, where one of the pressure controllers is configured to provide control signals to a pump associated with one of the ion guides and the other pressure controller can provide control signals to two pumps, each of which is associated with one of the other two pumps.

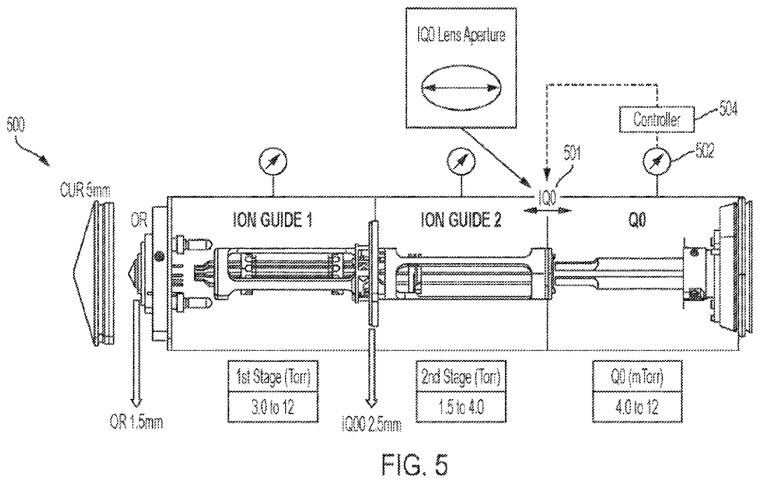

In some embodiments, the present teachings can be employed to regulate concurrently the operating pressures within multiple ion guides that are in fluid communication with one another. By way of example, FIG. 5 schematically depicts a mass spectrometer 500 that includes the above three ion guides 1, 2, and Q0 placed in tandem relative to one another. However, unlike the above embodiments in which the pressures in the ion guides are maintained independent of one another, in this embodiment, an adjustable lens aperture for IQ0 501 can be used to further adjust the pressure in Q0.

A pressure sensor 502 measures the operating pressure in the Q0 ion guide, and transmits the pressure data to a controller 504, which is configured as discussed herein, to apply control signals to the adjustable IQ0 lens aperture 501, in response to the received pressure data, so as to adjust the aperture diameter of the IQ0 lens associated with the flow restrictor in order to maintain the operating pressure within the Q0 ion guide within a desired pressure range, e.g., in this embodiment, in a range of about 3 mTorr to about 12 mTorr. Further, the operating pressure within the ion guide 1 and ion guide 2 is maintained in a desired range in a manner discussed above.

In some embodiments, in addition to or instead of employing a pressure sensor, one or more temperature sensors can be employed to measure the temperature at one or more selected locations relative to an ion guide. The temperature measurements can then be employed to calculate the pressure within the ion guide, e.g., by employing previously-obtained temperature-pressure calibration data. By way of example, such a temperature sensor can be positioned within an ion guide chamber. Alternatively, such a temperature sensor can be positioned external to the ion guide chamber.

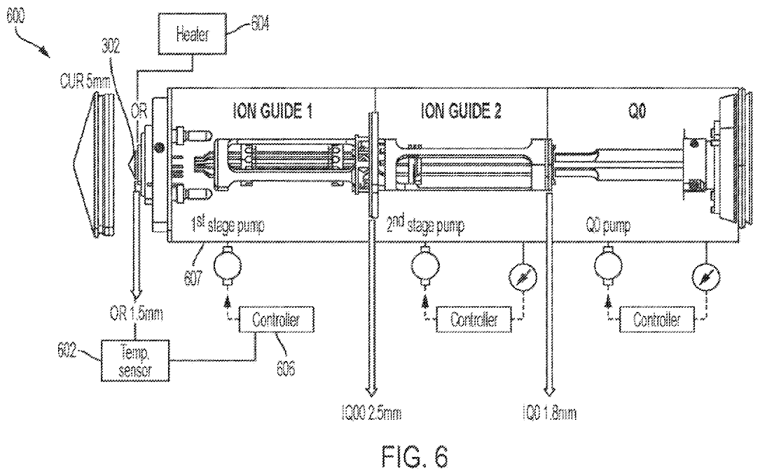

For example, FIG. 6 schematically depicts a mass spectrometer 600 according to such an embodiment in which a temperature sensor 602 is thermally coupled to the orifice plate 302 in proximity of its orifice to measure the temperature of the orifice plate, which in this embodiment is heated by a heater 604. The temperature sensor 602 is in communication with a controller 606 to provide the temperature data to the controller. In this embodiment, the controller is configured to correlate the received temperature data to the gas pressure within the ion guide 1, ion guide 2, or Q0.

In general, as the temperature of the orifice plate increases, so does the temperature of the gas in which the ions are entrained and which passes through the orifice of the orifice plate to reach the ion guide 1. Further, an increase in the temperature of the gas results in a decrease in the gas number density at the sampling inlet, and hence a decrease in gas conductance into downstream low-pressure stages. The controller 606 then compares the computed operating pressure with a desired pressure range or pressure value and applies control signals, based on such a comparison, to a flow restrictor positioned in the opening 607 in the wall of the ion guide chamber, which couples the ion guide chamber to a pump (not shown), in order to maintain the pressure within the chamber of the ion guide 1 in the desired range and/or value. In some embodiments, the temperature sensor 602 measures the temperature of the gas which entrains the ions. In other embodiments the temperature sensor 602 measures the temperature of other components in the curtain chamber, source region, or vacuum regions.

In some embodiments, the data from the temperature sensor can also be employed to compute the operating pressures in the downstream ion guides 2 and Q0, as well, and use the computed pressures to adjust the size of the aperture of the flow restrictors in the openings that fluidly couple the chambers to respective pumps to maintain the pressure in these ion guides within the desired ranges. Alternatively, the pressure within the downstream ion guides 2 and Q0 can be maintained within the desired ranges using the pressure sensors, e.g., in a manner discussed above.

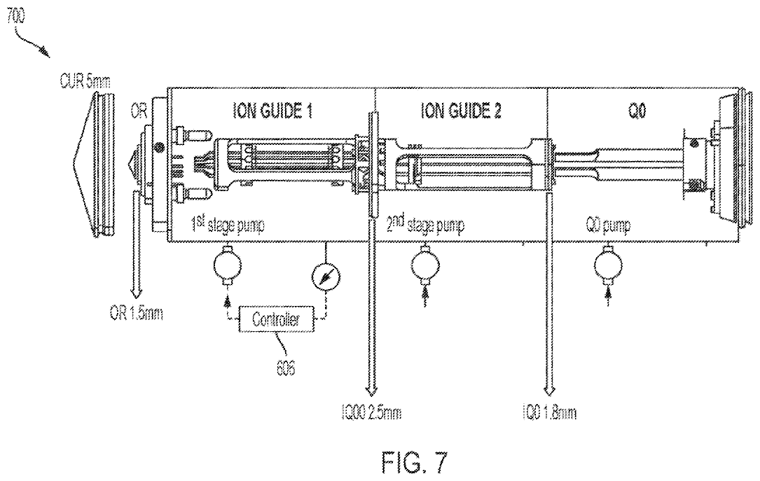

Further, in some embodiments, the active control of the operating pressure within an upstream ion guide can be employed to maintain the pressure not only in that ion guide but also in one or more downstream ion guides within a predefined range without actively controlling the operating pressure within those downstream ion guides. For example, FIG. 7 schematically depicts such a mass spectrometer 700, which includes the ion guides 1, 2 and Q0 placed in tandem. In this embodiment, the operating pressure within the ion guide 1 is actively controlled in a manner according to the present teachings whereas the operating pressure in each of the downstream ion guides 2 and Q0 is controlled passively by relying on the active maintenance of the operating pressure in the ion guide 1 within a desired range and/or a desired value. Some examples of various approaches that can be employed to maintain a desired operating pressure within a chamber containing an ion guide were discussed above, e.g., the use of a pressure sensor or a temperature sensor. In this embodiment, either ion guide 2 chamber or Q0 chamber is not connected to a pressure sensor. Alternatively, pressure sensors can be implemented in one or both of the two chambers to monitor the pressure change when the operating pressure in ion guide 1 is adjusted.

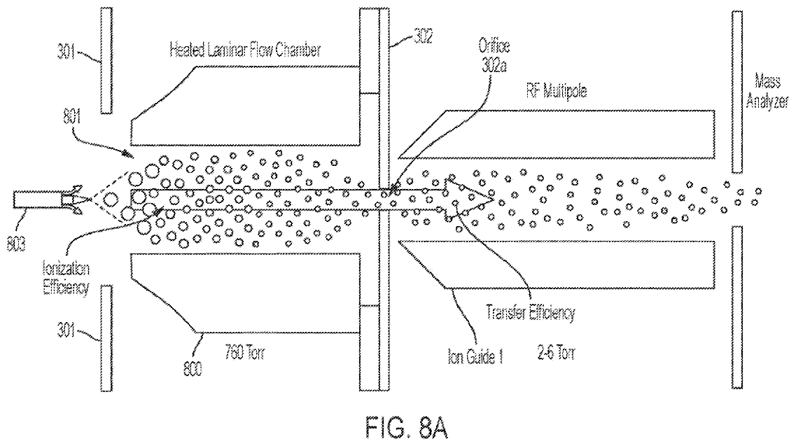

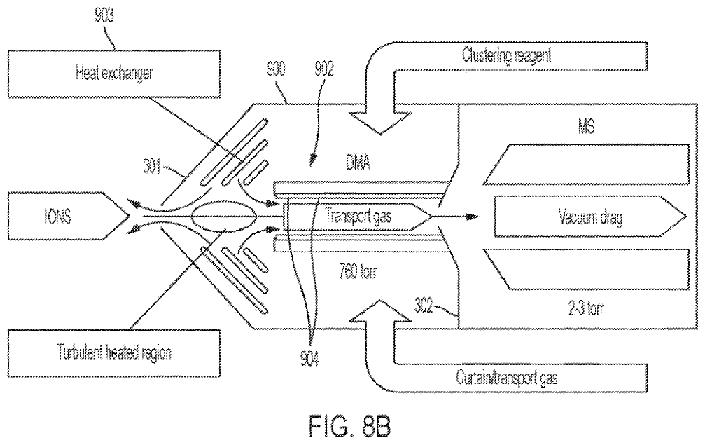

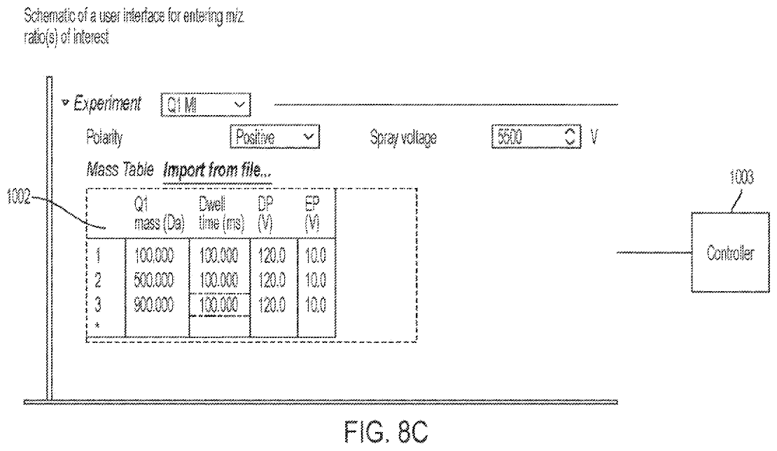

FIG. 8A is a partial schematic view of a mass spectrometer according to an embodiment in which a nanoflow interface 801 is positioned between the curtain plate 301 and the orifice plate 302. The nanoflow interface 801 includes a large bore heated laminar flow chamber 800, which can be sealed to the vacuum inlet between the curtain plate and the inlet orifice at atmospheric pressure. The flow chamber receives ions from an ion source 803 and a transport gas flowing through the chamber, which is drawn by the vacuum drag through the inlet orifice, delivers the received ions to the ion guide 1 of the mass spectrometer.

The composition of transport gas can be varied, such as nitrogen or nitrogen with varying amounts of gas or cluster reagents (gas modifiers). The laminar flow chamber includes an additional ceramic heater that can adjust the tube temperature from 50° C. to approximately 300° C., increasing the temperature of the transport gas. In some embodiments, the flow rate of the transport gas through the inlet orifice of the mass spectrometer can be, for example, in a range of about 0.5 to about 30 L/min.

FIG. 8B is a partial schematic view of another embodiment of a mass spectrometer 900 according to the present teachings, which includes a differential mobility spectrometer (DMS) 902 that is placed in the atmospheric region between the curtain plate 301 and interface orifice plate 302. The DMS 902 includes a pair of electrodes 904 that are mounted within the curtain chamber of the instrument and sealed to the vacuum inlet orifice. A transport gas is flowing through the cell, drawn from the curtain chamber by the vacuum drag through the inlet orifice. The composition of transport gas can be varied, such as nitrogen or nitrogen with varying amounts of an additional gas or cluster reagents (gas modifiers). The curtain plate includes a ceramic heat exchanger 903 to heat the transport gas. The DMS heat exchanger temperature can be set to 150° C. to 300° C. to effectively heat the transport gas to around 100° C. to 200° C. Other higher or lower temperatures can also be used. The mass spectrometer system 900 may include other features such as an additional chamber to separate the DMS electrodes from the orifice plate. The additional chamber may include a juncture chamber as described in U.S. Pat. No. 8,084,736, which is incorporated by reference.

In some embodiments, the pressure (or pressure range) in which one or more ion guides are desired to operate for optimized transmission can be selected based on the m/z ratio(s) of one or more target ions of interest. With reference to FIG. 8C, in some embodiments, a user interface 1000 can be used, e.g., by an operator, to enter one or more m/z ratios of interest. For example, in this embodiment, a graphical element 1002 in the form of a window can allow the entry of one or more m/z ratios of interest. The user interface can transmit the input to a controller 1003 that can then determine optimal pressures associated with various stages of the mass spectrometer for mass analysis of the ion(s) having the m/z ratio(s) of interest.

The following Examples are provided for further elucidation of various aspects of the present teachings and are not intended to necessarily indicate the optimal ways of practicing the present teachings and/or optimal results that may be obtained.

### Examples

A prototype SCIEX 7500 mass spectrometer similar to the mass spectrometer 300 discussed above in connection with FIG. 3B with a prototype DMS was employed to measure reserpine ionograms at different operating pressures of the Q0 ion guide. The diameter of the orifice plate's aperture was about 1.55 mm, exhibiting more than four-fold gas throughput increase relative to typical orifice diameters.

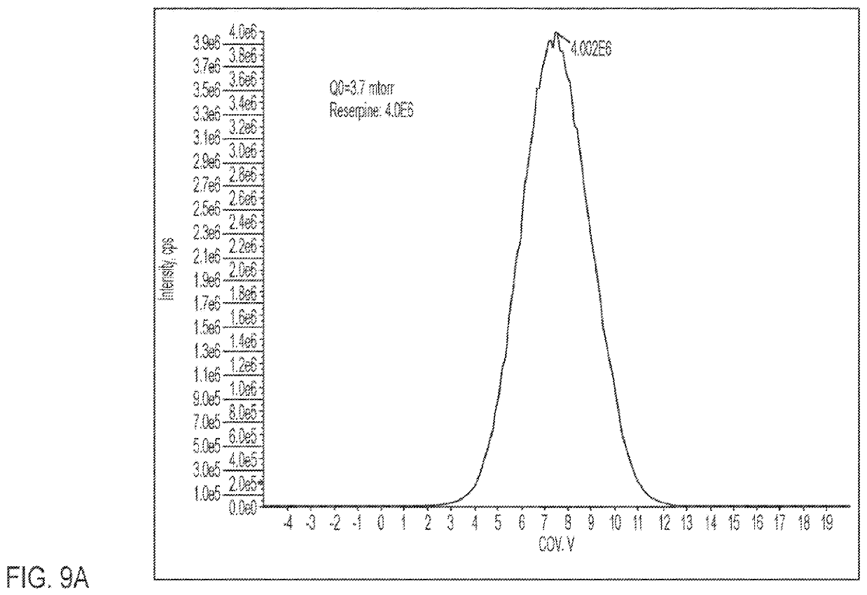

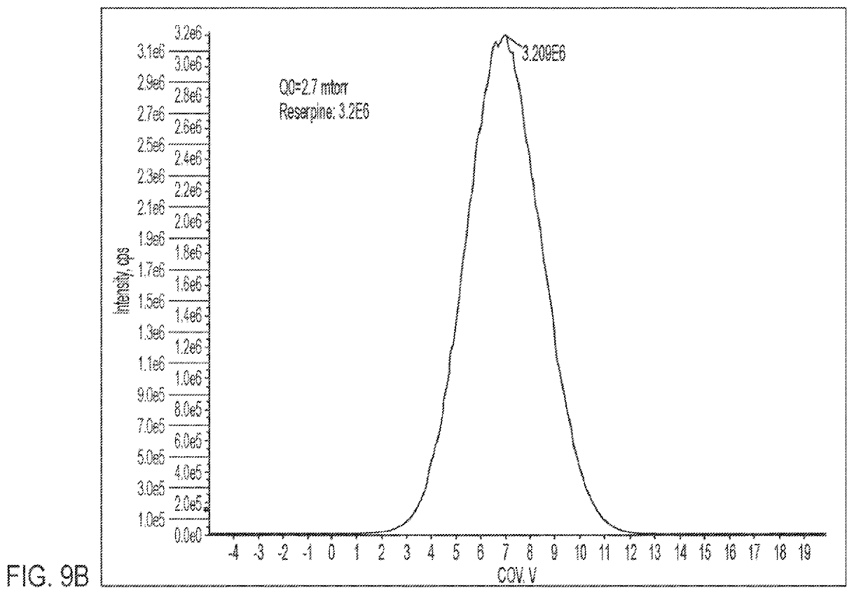

FIG. 9A shows the reserpine ionogram measured with Q0 pressure maintained at 3.7 mTorr with an 8 mm restrictor installed on the pump port, and FIG. 9B shows the reserpine ionogram measured with Q0 pressure maintained at 2.7 mTorr (no pump restrictor was applied), with infusion of reserpine at 10 μL/min. A DMS was applied with the cell heater set to 300° C. and the sampling inlet temperature set to 200° C. Optimization of the Q0 pressure to greater than 3 mTorr resulted in a 37% signal increase.

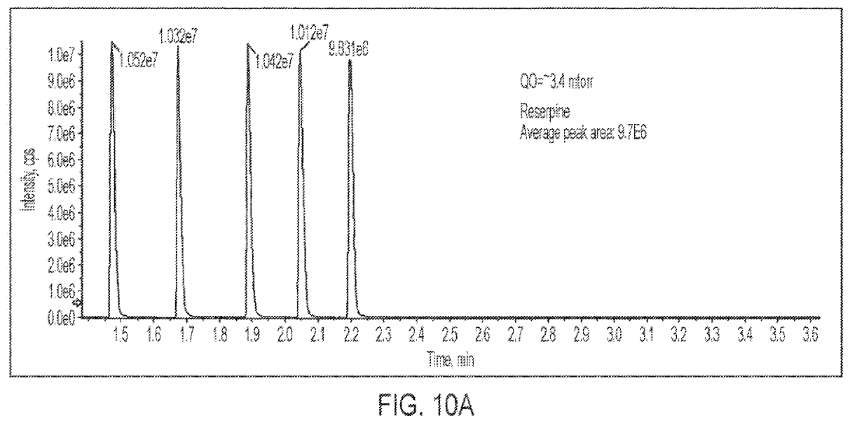

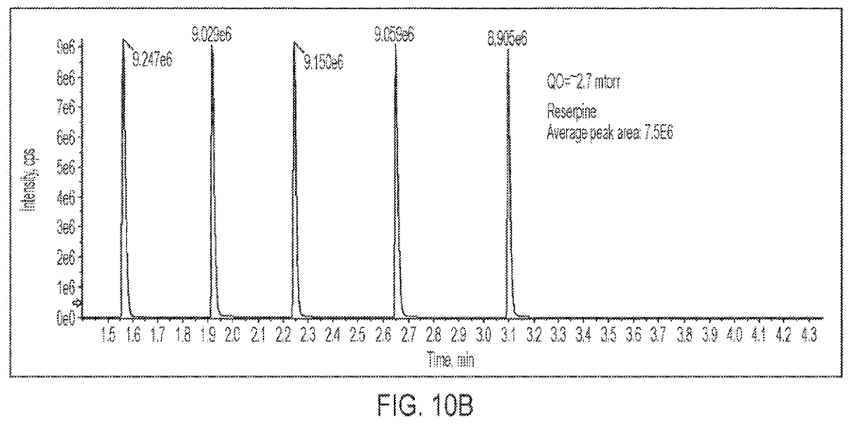

Each of FIGS. 10A and 10B depicts a series of peaks obtained for reserpine via flow injection of reserpine into the mass spectrometer with a DMS installed. The spectra shown in FIG. 10A were obtained with the pressure of the Q0 ion guide set at 3.4 mTorr and the spectra shown in FIG. 10B were obtained with the pressure of the Q0 ion guide set at 2.7 mTorr. Optimization of the Q0 pressure increased the signal intensity from 7.5×10⁶ cps to 9.7×10⁶ cps.

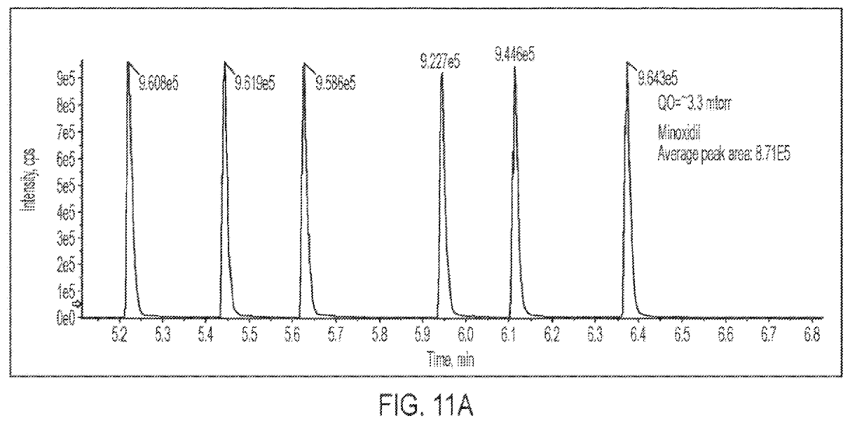

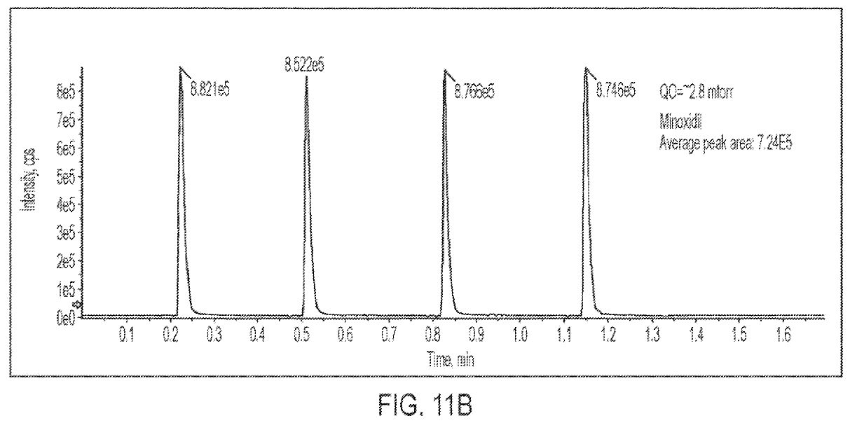

FIGS. 11A and 11B show a series of peaks obtained for minoxidil via flow injection of minoxidil into the mass spectrometer with a DMS installed. The data shown in FIG. 11A were obtained while the operating pressure of the Q0 ion guide was maintained at 3.3 mTorr and the data shown in FIG. 11B were obtained while the operating pressure of the Q0 ion guide was maintained at 2.8 mTorr. These data also show that a reduction in the operating pressure of the Q0 ion guide from 3.3 mTorr to 2.8 mTorr resulted in a reduction in the signal intensity (i.e., a reduction of the average peak area from 8.71×10⁵ to 7.24×10⁵). Optimization of the Q0 pressure to greater than 3 mTorr gave a 20% signal increase.

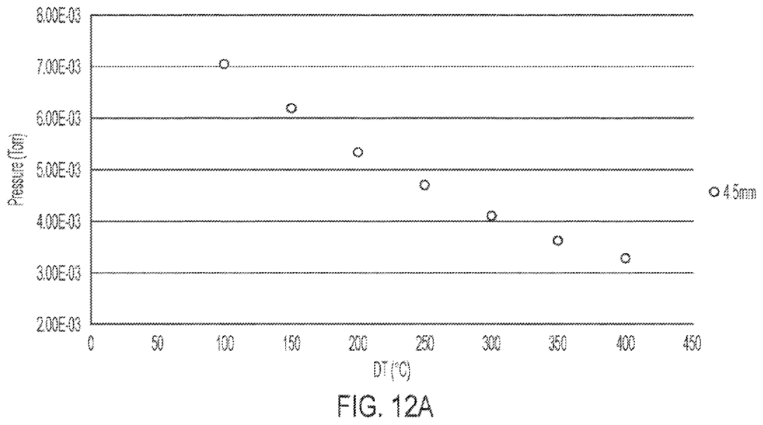

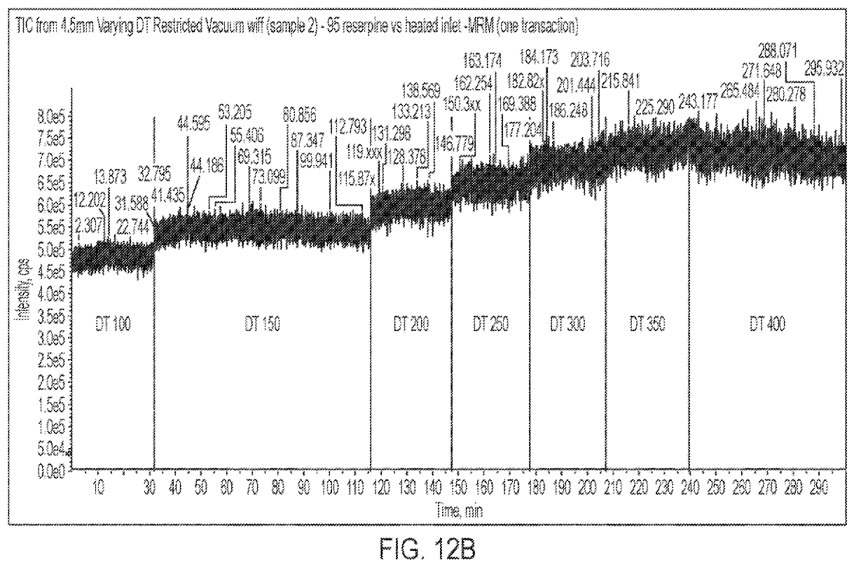

FIG. 12A shows the measured Q0 pressure on a prototype SCIEX 7500 system equipped with a custom nanoflow interface as a function of the temperature applied to the heater body connected to a heated laminar flow chamber. The system included a pumping configuration that was set up to ensure that the Q0 pressure would remain greater than 3 mTorr at the highest temperature setting (i.e., 400° C.). The data show that as the heated inlet temperature increases, the Q0 pressure decreases. By way of example, in some embodiments, such data can be employed to correlate temperature measurement data into pressure data, and employ the pressure data in a manner discussed herein to maintain the pressure within one or more ion guides within a desired range.

In some embodiments, one or more operating parameters of the mass spectrometer, e.g., one or more temperature settings associated with one or more heaters utilized for applying heat to one or more components of the mass spectrometer (e.g., an ionization chamber containing an ion source, the orifice plate, a DMS) can be utilized to determine the pressure in one or more ion guides of the mass spectrometer and to adjust the pressure, e.g., via adjusting the size of an adjustable aperture that fluidically couples the ion guide to a pump and/or adjusting the pump speed, if such an adjustment is needed to bring the operating pressure within the ion guide into a desired range. For example, the correlation between an operating parameter of the mass spectrometer and the pressure within an ion guide of interest can be derived from a previously-generated calibration curve. By way of example, in some embodiments, such a calibration curve can be generated by measuring the operating pressure within an ion guide as a function of a plurality of values for an operating parameter, e.g., a temperature setting associated with a heater applying heat to a component of the mass spectrometer (e.g., the orifice plate of the mass spectrometer). In some embodiments, such a calibration curve can be constructed by gathering calibration data across multiple mass spectrometers of the same type to generate a composite calibration curve that can employed when operating a mass spectrometer of that type.

By way of example, in some embodiments, such a calibration curve can provide a relation between the temperature setting associated with the operation of one or more heating elements of the mass spectrometer system and the pressure of an ion guide of interest. Examples of such heating elements whose operation (e.g., temperature setting) may be considered, alone or in combination, include an ion source heater, a DMS heat exchanger, a heating element utilized to heat the orifice plate of the mass spectrometer, a heated tube, pipe, or inlet capillary, a desolvation cell, and a nanoflow interface with a heated laminar flow chamber, all by way of non-limiting example. A controller, as otherwise discussed herein, can be in communication with the heating element to receive the temperature setting and adjust the pressure of the ion guide, e.g., via adjustment of the size of an adjustable aperture that fluidically couples the ion guide to a pump and/or the speed of the pump. For example, the controller can use the calibration data to calculate the pressure within the ion guide based on the temperature setting and compare the computed pressure with a predefined pressure range to determine if the computed pressure lies within that range. If the controller determines that the computed pressure lies outside the predefined range, the controller can effect a change in the aperture size and/or the pump speed to bring the pressure within the ion guide into the predefined range. By way of example, if the controller determines that the computed pressure exceeds a predefined threshold, the controller can adjust the adjustable pressure and/or the pump speed to lower the pressure within the ion guide below the predefined threshold as otherwise discussed herein.

FIG. 12B shows the reserpine ion signals that were obtained under these conditions, exhibiting an increase in signal intensity as the temperature increased to its highest temperature setting of 400° C. The increased heat improved desolvation/declustering to improve the reserpine ion signal.

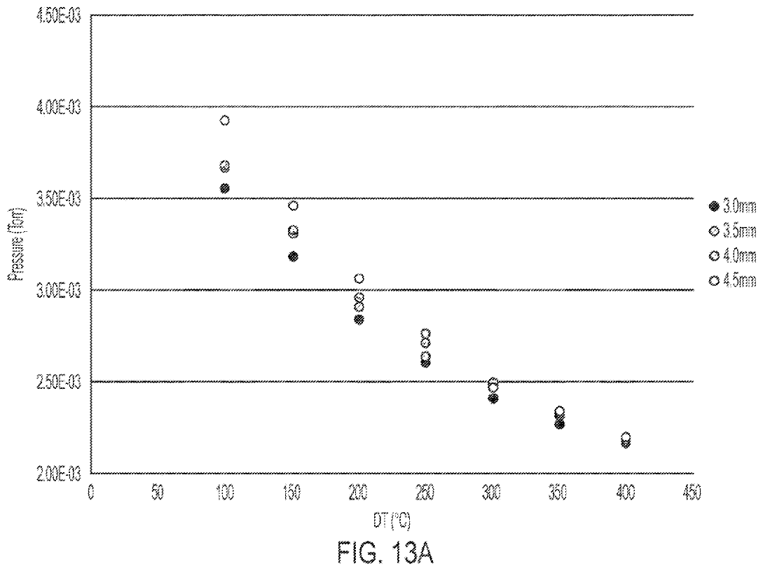

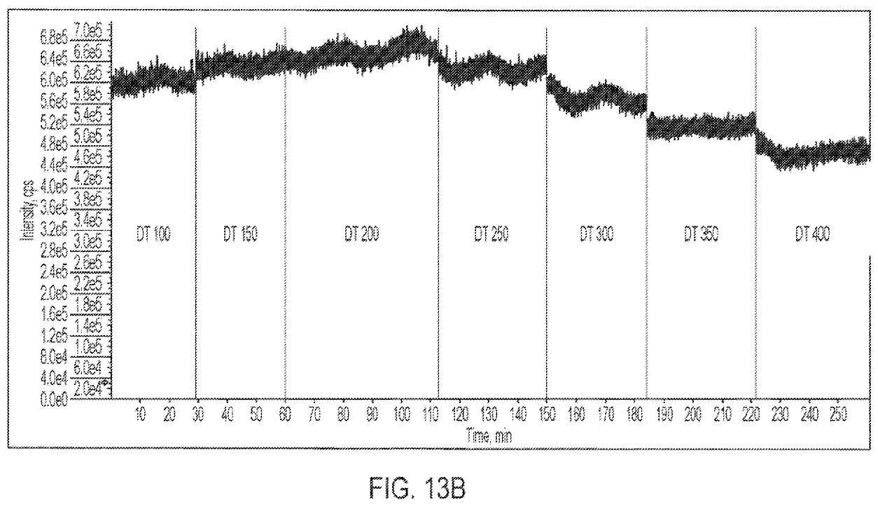

The collection of reserpine ion intensity data was repeated using a different pumping configuration that resulted in a pressure lower than 3 mTorr in the Q0 ion guide at the highest temperature setting of the heated inlet. FIG. 13A shows the change in the operating pressure of the Q0 as a function of the temperature on heated inlets with various internal diameter laminar flow chambers, and FIG. 13B shows the reserpine ion signal that was measured under these conditions. The data presented in FIG. 13B shows that the reserpine ion intensity increased with increasing temperature up to a temperature of 200° C. at the heated inlet. However, the reserpine ion signal began to drop due to insufficient collisional cooling as a result of low Q0 pressure when the inlet temperature exceeded 200° C.

As described above with reference to the Q0 region, when the pressure drops too low, it can be impractical to provide an effective collisional cooling of the ions, which can in turn result in signal loss. The same phenomena can occur in the DJET and QJET regions, where it is desirable to maintain the pressure above about 4 Torr and 1.8 Torr, respectively. However, it is also important to ensure that an increase in the pressure will not be too high. For the DJET region, pressures above 8 Torr can result in signal instability due to beaming. Similarly, ion transmission through the QJET can be negatively impacted by pressures above about 4 Torr. The Q0 region typically includes additional pumping from a turbomolecular pump, which can overheat if the pressure is greater than 12 mTorr for an extended period of time. Therefore, different ion guides will have different optimal pressure regimes and it is also important to limit the maximum pressure for a given pumping region.

Without being limited to any particular theory, increasing the temperature of the heated inlet results in a reduction of the gas number density at the sampling inlet, thereby leading to a reduced pressure within the mass spectrometer. In the instrument that was employed for the above measurements, the decrease in the gas pressure is significant when the nanoflow inlet heater was set to 200° C. or higher and/or the ion source heaters warm up to around 750° C. The DMS hardware also provides an additional heat exchanger (labeled 903 in FIG. 8B) that can further reduce pressure in the DJET, QJET, or Q0 regions.

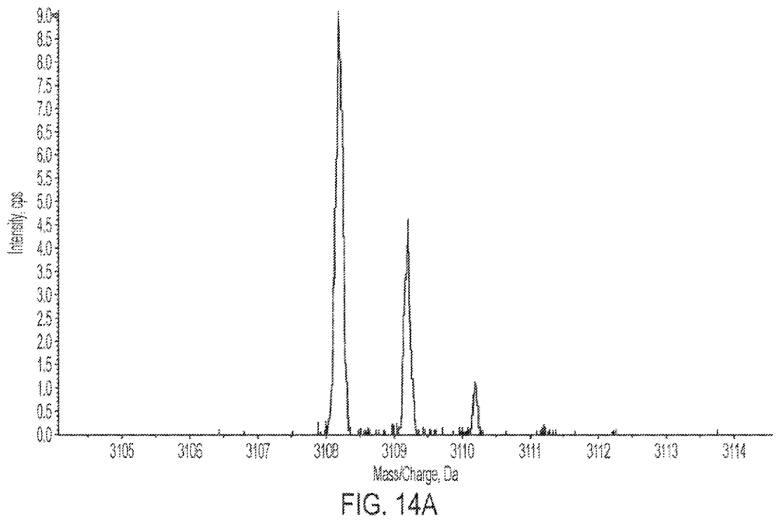

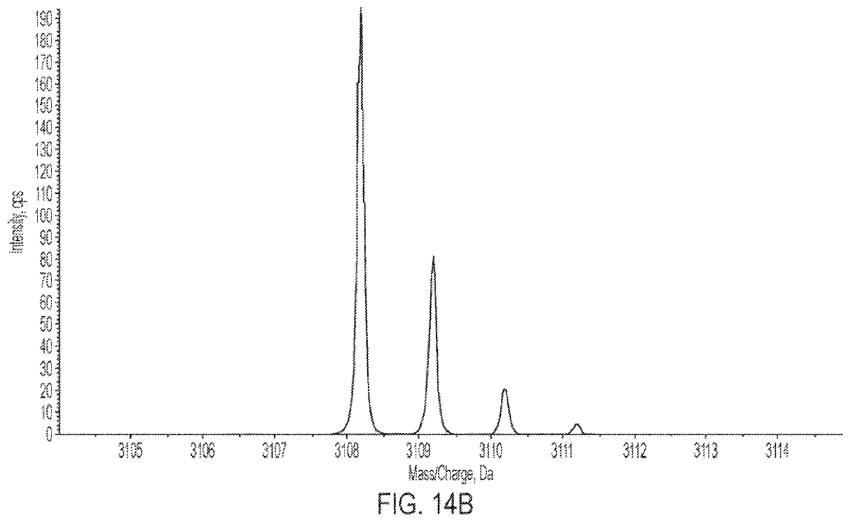

By way of further illustration, FIG. 14A shows a mass spectrum of a cesium cluster ion having an m/z of approximately 3108 obtained using a breadboard time-of-flight mass spectrometry system with 3-stage DJET front end configured for receiving very large molecules. The mass spectrum presented in FIG. 14A was obtained with the pressure of the Q0 ion guide at a value less than 5 mTorr.

FIG. 14B shows the mass spectrum for the same ion obtained with the pressure of the Q0 ion guide at 7 mTorr. This data shows that an optimal pressure in the Q0 can vary based on the m/z ratio of an ion of interest. For example, in some embodiments, an optimal Q0 pressure for mass analysis of high m/z ions (e.g., ions having an m/z ratio greater than about 1000) may be in a range of about 7 mTorr to about 10 mTorr while an optimal Q0 pressure for mass analysis of lower m/z ions may be in a range of about 4 mTorr to about 7 mTorr.

In a series of experiments, the pressure in Q0 with the use of a flow restrictor with an inner diameter (id) of 8 mm was compared to a respective pressure in Q0 without a flow restrictor. In these experiments, a Q0 pressure of 6 mTorr was observed without a flow restrictor and without heating. When the DMS cell was heated with the cell heater set at 300° C., a Q0 pressure of less than 3 mTorr was observed without a flow restrictor. The use of a flow restrictor with an internal diameter (id) of 8 mm resulted in a Q0 pressure of about 10 mTorr without heating, and a pressure of about 4 mTorr when the DMS cell was heated with the cell heater set at 300° C. and a pressure of 3 mTorr or lower when the ion source turbo heaters were used with a TEM=750° C.

Similar experiments conducted using a heated nanoflow interface rather than a DMS showed that the adjustment of the Q0 pressure can be used for optimizing the mass signal. These results demonstrate that it can be difficult to maintain a desired pressure range in various vacuum stages of a 3-stage differentially pumped vacuum stages of a mass spectrometer when applying varying levels of heat in the ion source and interface regions. This difficulty is compounded when accessories such as DMS or a nanoflow ESI interface with different heating characteristics are added to the system.

Those having ordinary skill in the art will appreciate that various changes can be made to the above embodiments without departing from the scope of the present teachings.

1-23. (canceled)

24. A differentially pumped vacuum stage for use in a mass spectrometry system, comprising:
a plurality of chambers differentially pumped to have different pressures including at least a first chamber positioned upstream of a second chamber and in fluid communication therewith, wherein an operating pressure of the first chamber is greater than an operating pressure of the second chamber,
a pressure sensor operably coupled to said second chamber for measuring the operating pressure of said second chamber and generating one or more pressure signals, and
a controller in communication with said pressure sensor and configured to generate one or more control signals in response to said one or more pressure signals to adjust the operating pressure of the first chamber so as to maintain the operating pressure of the second chamber within a target range or at a target value.

25. The differentially pumped vacuum stage of claim 24, further comprising a first pump operably coupled to said first chamber via a first opening for applying a negative pressure to said first chamber.

26. The differentially pumped vacuum stage of claim 25, wherein said controller is configured to apply the one or more control signals to said first pump for adjusting at least one operational parameter thereof so as to adjust the operating pressure of the first chamber.

27. The differentially pumped vacuum stage of claim 26, wherein said at least one operational parameter of the first pump comprises any of a pumping speed and a frequency of the pump.

28. The differentially pumped vacuum stage of claim 25, further comprising an adjustable flow restrictor coupled to said opening and configured to adjust a flow conductance between the first chamber and the first pump so as to adjust the operating pressure of the first chamber.

29. The differentially pumped vacuum stage of claim 28, wherein said adjustable flow restrictor comprises an adjustable aperture and said one or more control signals adjust a size of said adjustable aperture.

30. The differentially pumped vacuum stage of claim 24, further comprising a first ion guide positioned in said first chamber and a second ion guide positioned in said second chamber, wherein each of said first ion guide and said second ion guide provides a passageway for transit of ions therethrough.

31. The differentially pumped vacuum stage of claim 30, wherein any of said target range and said target value corresponds to a pressure range or a pressure value providing an optimal transmission of ions having m/z ratios in a predefined range through any of said first and said second ion guide and/or an optimal declustering of one or more cluster ions.

32. The differentially pumped vacuum stage of claim 24, wherein said target range is from about 3 mTorr to about 8 Torr.

33. The differentially pumped vacuum stage of claim 30, wherein said first chamber is in fluid communication with an upstream sampling orifice of said mass spectrometer for receiving ions generated by an ion source of the mass spectrometer.

34. The differentially pumped vacuum stage of claim 24, further comprising a third chamber positioned between said first and said second chamber and in fluid communication therewith.

35. The differentially pumped vacuum stage of claim 34, wherein the one or more control signals are further configured to adjust, in addition to the operating pressure of the first chamber, an operating pressure of the third chamber so as to maintain the operating pressure of the second pressure within the target range or at the target value.

36. The differentially pumped vacuum stage of claim 35, further comprising a second pump operably coupled to said third chamber via a second opening for applying a negative pressure thereto.

37. The differentially pumped vacuum stage of claim 36, wherein the one or more control signals are configured to adjust at least one operational parameter of said second pump for adjusting said operating pressure of the third chamber.

38. In a differentially pumped vacuum stage for use in a mass spectrometry system, a method for maintaining an operating pressure of a target chamber within a desired range or at a desired value, the method comprising:
monitoring an operating pressure of the target chamber, and
adjusting an operating pressure of one or more chambers positioned in tandem and upstream of said target chamber and in fluid communication therewidth in response to the monitored pressure of the target chamber so as to maintain the operating pressure of the target chamber within said desired range or at said desired value.

39. The method of claim 38, wherein the operating pressure of any one of the one or more upstream chambers is greater than an operating pressure of the target chamber.

40. The method of claim 38, further comprising utilizing a pressure sensor operably coupled to said target chamber for monitoring the pressure of the target chamber.

41. The method of claim 38, wherein the step of adjusting the operating pressure of the one or more upstream chambers comprises adjusting at least one operational parameter of one or more pumps operably coupled to said one or more upstream chambers.

42. The method of claim 41, wherein said at least one operational parameter comprises any of a pumping speed and frequency of said one or more pumps.

43. The method of claim 38, wherein said step of adjusting the operating pressures of the one or more upstream chambers comprises adjusting aperture size of at least one adjustable flow restrictor operably coupled to at least one of said one or more chambers.
